(19) United States
(12) Patent Application Publication
(10) Pub. No.: US 2009/0002258 A1
(43) Pub. Date: Jan. 1, 2009

(54) EXTENDIBLE ANTENNA STRUCTURE AND SWITCHING ARRANGEMENT THEREFOR

(75) Inventor: ALEJANDRO CANDAL, Davie, FL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/768,992

(22) Filed: Jun. 27, 2007

(51) Int. Cl. H01Q 1/52

(52) U.S. Cl. 343/876

(57) ABSTRACT

A mobile communication device (100) uses an extendible antenna structure (200) in addition to a fixed antenna element (401). The extendible antenna structure has first and second conductor elements (210, 212) which are arranged to connect different antenna arrangements to corresponding matching networks (124, 126). A first conductor element couples the fixed antenna element and an antenna element in the extendible antenna structure together to the first matching network when the extendible antenna element is in an extended position. A second conductor element connects the fixed antenna alone to the second matching network when the extendible antenna element is in the retracted position.

### FIELD OF THE INVENTION

The invention relates generally to antenna arrangements for portable and mobile communication device, and more particularly to extendible antenna structures which include a fixed antenna element.

### BACKGROUND OF THE INVENTION

Mobile communication devices have become widely popular, and serve a variety of needs in addition to voice communication. These devices transmit and receive radio signals according to an established air interface. There are a number of factors which determine the success of a given mobile communication device design in the marketplace, including the overall size of the device and the battery life of the device. Manufacturers have sought to, generally, reduce the size of these devices and also decease power consumption. Often these two design factors conflict, and enhancing one results in a detriment to the other. For example, decreasing the size of the device may cause the antenna geometry to be such that more power is needed when transmitting and receiving due to the effect the human body has on antenna performance when the mobile communication device is held. An extendible antenna can alleviate some radio frequency performance issues, but if the user is close to base station, the antenna does not necessarily need to be extended. However, the antenna impedance can change as the antenna is moved from retracted to extended positions. Accordingly, different matching is needed to preserve radio frequency performance.

### SUMMARY OF THE INVENTION

The present invention discloses an extendible antenna system for a mobile communication device. The system includes a fixed antenna element and an extendible antenna structure. The extendible antenna structure includes an extendible antenna element, and is moveable between an extended position and a retracted position. The extendible antenna structure further includes top portion and a bottom portion, the top and bottom portions each have a conductor element disposed or mounted therein. The extendible antenna element is electrically connected to the conductor element of the bottom portion and insulated from the conductor element of the top portion. The antenna system further comprises first and second matching networks coupled to a transceiver of the mobile communication device. When the extendible antenna structure is in the extended position the conductor of the bottom portion electrically couples the fixed antenna element and the extendible antenna element together to the first matching network, and when the extendible antenna structure is in the retracted position the conductor element of the top portion electrically couples the fixed antenna element to the second matching network.

In another embodiment of the invention, there is provided mobile communication device using an antenna system in accordance with the invention. The mobile communication device includes a transceiver, which has a receiver and a transmitter. The mobile communication device further includes an extendible antenna system which has a fixed antenna element and an extendible antenna structure. The extendible antenna structure includes an extendible antenna element, such as, for example, a wire whip element. The extendible antenna structure is moveable between an extended position and a retracted position, and has a first connector portion and a second connector portion. The first and second connector portions each have a conductor element disposed therein. The extendible antenna element is electrically connected to the conductor element of the second connector portion, and insulated from the conductor element of the first connector portion. The antenna system further includes first and second matching networks coupled to the transceiver. When the extendible antenna structure is in the extended position the conductor element of the second connector portion electrically couples the fixed antenna element and the extendible antenna element together to the first matching circuit. When the extendible antenna structure is in the retracted position the conductor element of the first connector portion electrically couples the fixed antenna element to the second matching circuit.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 shows a block schematic diagram of a mobile communication device including an extendible antenna system, in accordance with the invention;

FIG. 2 shows a extendible antenna structure, in accordance with an embodiment of the invention;

FIG. 3 shows alternate views of a mobile communication device with the antenna extended and retracted;

FIG. 4 shows a schematic diagram of a switching arrangement for an extendible antenna system, in accordance with the invention;

FIG. 5 shows a switching arrangement for an extendible antenna system with the extendible antenna structure in a second position, in accordance with an embodiment of the invention;

FIG. 6 shows a switching arrangement for an extendible antenna system with the extendible antenna structure in a first position, in accordance with an embodiment of the invention.

### DETAILED DESCRIPTION OF THE INVENTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

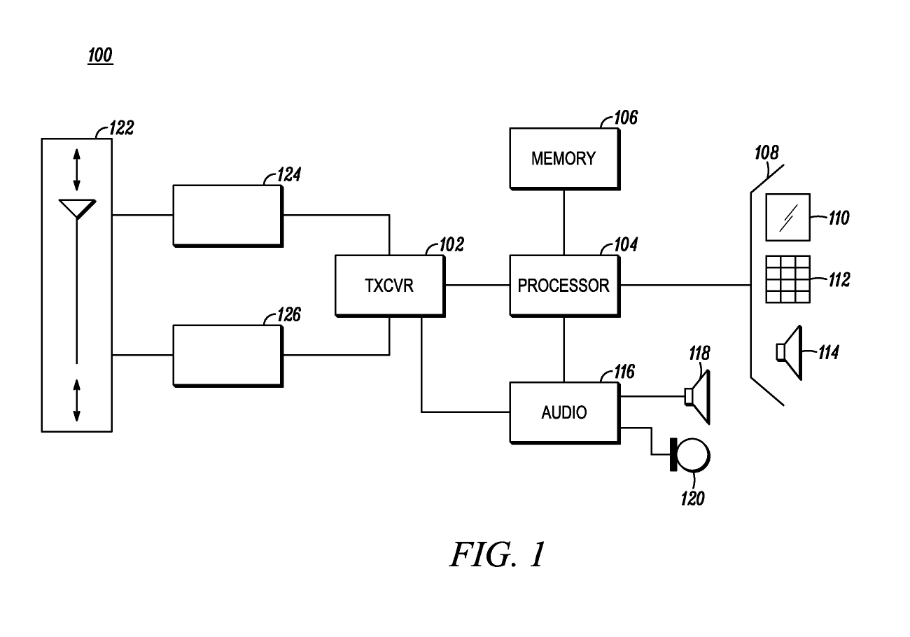

Referring now to FIG. 1, there is shown generally therein a block schematic diagram of a mobile communication device 100 including an extendible antenna system 122, in accordance with the invention. The mobile communication device facilitates voice and data communication in a wireless manner over one or more radio air interface protocols with terrestrial communication stations, and may communicate directly with other mobile communication devices. To facilitate radio communication, the mobile communication device includes a transceiver 102. The transceiver includes a radio transmitter, receiver, modulator/demodulator, frequency generation circuitry, filters, amplifiers, gain control, processing, and other necessary circuitry, as is known in the art. The transceiver operates under control and supervision of a central processor 104. The central processor control high level operation of the mobile communication device, and processes information received from the transceiver and user. In some arrangements the central processor may be an application processor, wherein a baseband processor would be included in the transceiver 102, in accordance to at least some known mobile communication device arrangements. The central processor 104 operates in accordance with instruction code stored, for example, in a memory 106. As depicted here, memory 106 represents an aggregate memory of the mobile communication device, and would include permanent, semi-permanent or reprogrammable, and variable memory for storing present values of variable, instantiating code, and so on. To facilitate control of operation of the mobile communication device by a user, the mobile communication device includes a user interface 108, including such well-known elements as a graphical display 110, buttons and keypads 112, and audible transducers 114 for alerts, tones, etc. Other user interface elements may be provided as is known. To facilitate voice communication, the mobile communication device includes an audio processor 116. The audio processor receives digital audio and converts it to analog audio to be played over a speaker or earpiece 118. Similarly, a microphone 120 collects audio signals and converts them to analog electrical signals which are converted to digital audio signal by the audio processor 116 for transmission by the transceiver 102.

To facilitate radio communication, the mobile communication device of the present invention utilizes an extendible antenna system 122. The extendible antenna system includes an extendible antenna structure that is moveable between extended and retracted positions. The extendible antenna system may further include a fixed antenna element. As the impedance characteristics change when the extendible antenna structure is moved from one position to the other, different matching networks 124, 126 are used to match the impedance of the antenna system to the transceiver. A first matching network 124 may be used when the extendible antenna structure is extended, and the second matching network 126 may be used when the extendible antenna structure is in a retracted position. The extendible antenna system 122 includes a switching arrangement so that the appropriate matching network 124, 126 is coupled to the antenna system as the extendible antenna structure is moved.

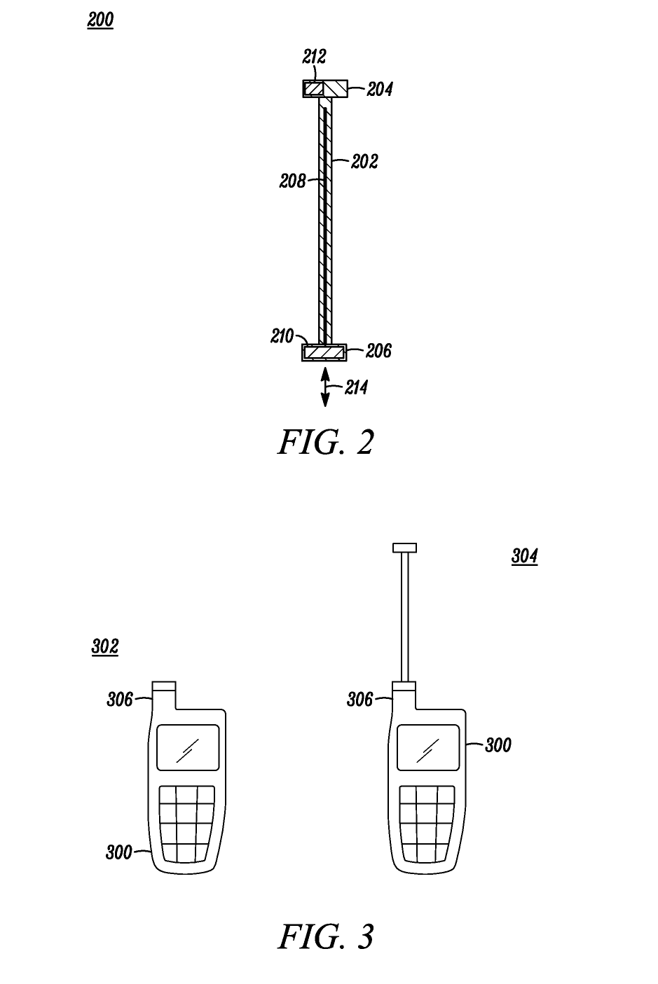

FIG. 2 shows a cross sectional view of an extendible antenna structure 200, in accordance with an embodiment of the invention. The extendible antenna structure included a generally longitudinal body 202 which defines an axis of movement 214 for extending and retracting the antenna. The extendible structure will be mounted and guided so that it may be moved in the mobile communication device, as is known. The extendible antenna structure has a top portion 204 and a bottom portion 206. As used here “top” and “bottom” are names of convenience to show a relation that the top portion extends farther from the mobile communication device body when the extendible antenna structure is extended, while the bottom portion remains inside the mobile communication device. Generally they are connector portions because they contain elements for making electrical connection. They may be placed at different places along the body of the extendible antenna structure and not only at the terminal ends, as shown here, and as will be appreciated by those skilled in the art. Generally, the body of the extendible antenna structure is a non-conductive material which carries conductive components, as described herein. Disposed inside the extendible antenna structure is the extendible antenna element 208, which is, for example, a whip element comprised of a nickel-titanium wire. Generally the extendible antenna element is fabricated of an electrically conductive material, and is formed in a preselected shape and length, depending on the application. The extendible antenna element 208 is electrically connected to a conductor element 210 disposed in the bottom portion 206. The conductor element 210 of the present example substantially spans the width of the bottom portion of the extendible antenna structure, and has an exposed surface to make electrical contact with two or more conductor pads (408 and 402) to electrically couple the pads together when the extendible antenna structure is in the extended position. Thus, the orientation and shape of the conductor element 210 corresponds to the arrangement of the conductor pads which it will couple together when the extendible antenna structure is in the appropriate position.

Similarly, the top portion 204 also contains a conductor element 212. Whereas the conductor element of the bottom portion may be arranged to connect, for example, a first and second conductor pad together, the conductor element of the top portion may conversely be arranged to connect the first conductor pad with a third conductor pad when the extendible antenna structure is in the retracted position. Thus, it will be appreciated by those skilled in the art that the bottom portion will be physically located substantially the same region of the mobile communication device when it the extendible antenna structure is on the extended position as the top portion will be located when the extendible antenna structure is in the retracted position. The conductor pads discussed so far, as will be shown in more detail herein, are fixed in position. Thus, moving the extendible antenna structure produces a switching function.

Referring now to FIG. 3, there is shown alternate views of a mobile communication device 300 with an extendible antenna structure. The extendible antenna structure, which may alternatively be referred to as a retractable antenna structure, is shown in a retracted position 302, and in an extended position 304. Note that the top portion at least partially seats with the mobile communication device when the extendible antenna structure is retracted to allow the conductor element 212 to make contact with connector or conductor pads disposed in the mobile communication device or in an antenna boss 306 of the mobile communication device.

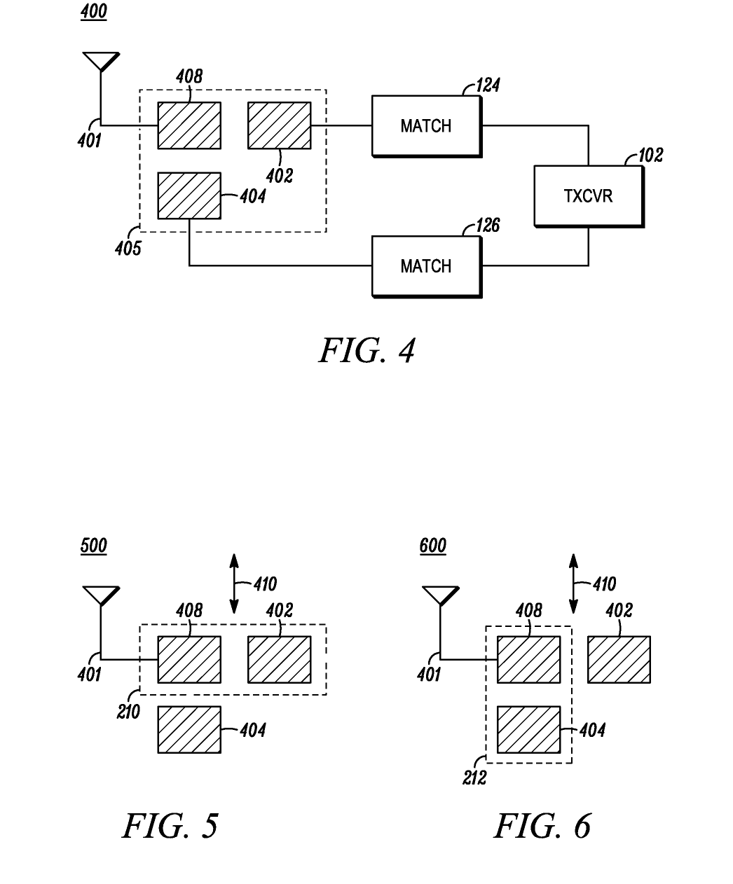

Referring now to FIG. 4, there is shown a schematic diagram of a switching arrangement 400 for an extendible antenna system, in accordance with the invention. The switching arrangement controls switching the connection of either the first matching network 124 or second matching network 126 to the antenna structure, depending on the position of the extendible antenna structure. The aggregate antenna structure may include, in addition to the extendible antenna structure, a fixed antenna element 401. The fixed antenna element may be, for example, a conductor disposed on a circuit board of the mobile communication device, including a flexible circuit board component. The particular design and arrangement of the fixed antenna element 401 may be selected in view of the application for which it is being used, and in view of the layout of the mobile communication device.

As shown in the present example, the first matching network 124 is coupled to a first conductor pad 402. A conductor pad comprises a region of exposed conductor used to make electrical contact with other elements. A conductor pad may be easily formed on a circuit board by simply providing an opening in the outermost non-conductive layer of the circuit board over a region of conductor. Similarly, the second matching network 126 is coupled to a second conductor pad 404, and the fixed antenna element 401 is coupled to a third conductor pad 408. The three conductor pads are substantially co-located in a common region 405 of a circuit board or other suitable substrate. The arrangement of the conductor pads 402, 404, and 408 is such that the first and third conductor pads correspond to the arrangement of the conductor element 210 of the bottom portion 206 of the extendible antenna structure, while the arrangement of the second and third conductor pads correspond to the arrangement of the conductor element 212 of the top portion 204 of the extendible antenna structure. FIGS. 5 and 6 show the utility of the arrangement.

Referring now to FIG. 5, there is shown a switching arrangement for an extendible antenna system with the extendible antenna structure in an extended position 500, in accordance with an embodiment of the invention. The first, second, and third conductor pads 402, 404, and 408 respectively, are shown, along with the fixed antenna element 401. The extendible antenna structure moves along axis 410 with respect to the arrangement of the conductor pads. When the extendible antenna structure is in the extended position, the conductor element 210 of the bottom portion of the extendible antenna structure overlaps the positions of the first and third conductor pads, and makes contact with them, thus electrically coupling them together such that the extendible antenna element 208 and fixed antenna element 401 are coupled together to the first matching network 124. Similar to FIG. 5, FIG. 6 shows a switching arrangement for an extendible antenna system with the extendible antenna structure in a retracted position 600, in accordance with an embodiment of the invention. When the extendible antenna structure is in the retracted position, the top portion of the extendible antenna structure is located in proximity to the conductor pads, and the conductor element 212 of the top portion 204 of the extendible antenna structure overlaps the positions of the second and third conductor pads and makes electrical contact with the second and third conductor pads. Thus, when the extendible antenna structure is in the retracted position, the fixed antenna element, alone, is coupled to the transceiver through the second matching network 126.

To facilitate the necessary electrical connections to produce the desired switching effect in accordance with the present invention, it is contemplated the conductor elements 210 and 212 extend outward slightly from the side of the bottom or top portions of the extendible antenna structure. Furthermore, a bump or similar protrusion may be disposed inside the mobile communication device, opposing the conductor pads, which forces the top and bottom portions of the extendible antenna structure towards the conductor pads when in the extended or retracted positions. Alternatively, for example, the conductor elements 210, 212 may be moveably retained in their respective portions of the extendible antenna structure and biased outwards by a suitable spring means. Those skilled in the art will appreciate that there are a variety of means for ensuring contact between the conductor elements and the conductor pads, as taught by the invention.

This invention can be embodied in other forms without departing from the spirit or essential attributes thereof. Accordingly, reference should be made to the following claims, rather than to the foregoing specification, as indicating the scope of the invention.

What is claimed is:

1. An extendible antenna system for a mobile communication device, comprising:
a fixed antenna element;
an extendible antenna structure including an extendible antenna element, the extendible antenna structure moveable between an extended position and a retracted position, and having a top portion and a bottom portion, the top and bottom portions each having a conductor element, the extendible antenna element being electrically connected to the conductor element of the bottom portion and insulated from the conductor element of the top portion;
a first matching network coupled to a transceiver of the mobile communication device; and
a second matching network coupled to the transceiver of the mobile communication device;
wherein when the extendible antenna structure is in the extended position the conductor of the bottom portion electrically couples the fixed antenna element and the extendible antenna element together to the first matching network; and
wherein when the extendible antenna structure is in the retracted position the conductor element of the top portion electrically couples the fixed antenna element to the second matching network.

2. An extendible antenna system as defined in claim 1, wherein the fixed antenna element is disposed on a circuit board of the mobile communication device.

3. An extendible antenna system as defined in claim 2, wherein the circuit board is a flexible circuit board.

4. An extendible antenna system as defined in claim 1, wherein the extendible antenna element is comprised of a whip antenna element.

5. An extendible antenna system as defined in claim 4, wherein the whip antenna element is comprised of nickel-titanium wire.

6. An extendible antenna system as defined in claim 1, wherein the first matching network is electrically coupled to a first conductor contact pad disposed on circuit board of the mobile communication device, the second matching network is coupled to a second conductor contact pad disposed on the circuit board, the fixed antenna element is electrically coupled to a third conductor contact pad disposed on the circuit board;
the conductor element of the bottom portion of the extendible antenna structure electrically connects the first and third conductor contact pads when the extendible antenna structure is in the extended position; and
the conductor element of the top portion of the extendible antenna structure electrically connects the second and third conductor contact pads when the extendible antenna structure is in the retracted position.

7. A mobile communication device, comprising:
a transceiver including a receiver and a transmitter;
an extendible antenna system, comprising:
a fixed antenna element;
an extendible antenna structure including an extendible antenna element, the extendible antenna structure moveable between an extended position and a retracted position, and having a first connector portion and a second connector portion, the first and second connector portions each having a conductor element disposed therein, the extendible antenna element being electrically connected to the conductor element of the second connector portion and insulated from the conductor element of the first connector portion;
a first matching network coupled to the transceiver; and
a second matching network coupled to the transceiver;
wherein when the extendible antenna structure is in the extended position the conductor element of the second connector portion electrically couples the fixed antenna element and the extendible antenna element together to the first matching network; and
wherein when the extendible antenna structure is in the retracted position the conductor element of the first connector portion electrically couples the fixed antenna element to the second matching network.

8. A mobile communication device as defined in claim 7, wherein the fixed antenna element is disposed on a circuit board of the mobile communication device.

9. A mobile communication device as defined in claim 8, wherein the circuit board is a flexible circuit board.

10. A mobile communication device as defined in claim 7, wherein the extendible antenna element is comprised of a whip antenna element.

11. A mobile communication device as defined in claim 10, wherein the whip antenna element is comprised of nickel-titanium wire.

12. A mobile communication device as defined in claim 7, wherein the first matching network is electrically coupled to a first conductor contact pad disposed on a circuit board of the mobile communication device, the second matching circuit is coupled to a second conductor contact pad disposed on the circuit board, the fixed antenna element is electrically coupled to a third conductor contact pad disposed on the circuit board;
the conductor element of the second connector portion of the extendible antenna structure electrically connects the first and third conductor contact pads when the extendible antenna structure is in the extended position; and
the conductor element of the first connector portion of the extendible antenna structure electrically connects the second and third conductor contact pads when the extendible antenna structure is in the retracted position.

13. A mobile communication device as defined in claim 7, wherein the first connector portion is disposed on a top portion of the extendible antenna structure.

14. A mobile communication device as defined in claim 7, wherein the second connector portion is disposed on a bottom portion of the extendible antenna structure.
